(19) United States
(12) Patent Application Publication
(10) Pub. No.: US 2025/0077053 A1
(43) Pub. Date: Mar. 6, 2025

(54) METHODS, APPARATUS, ELECTRONIC DEVICE AND STORAGE MEDIA FOR INFORMATION PROCESSING

(71) Applicant: Beijing Zitiao Network Technology Co., Ltd., Beijing (CN)

(72) Inventor: Lingyu WANG, Beijing (CN)

(21) Appl. No.: 18/727,323

(22) PCT Filed: Jan. 3, 2023
(86) PCT No.: PCT/CN2023/070088

§ 371 Date: Jul. 8, 2024

(30) Foreign Application Priority Data
Jan. 7, 2022 (CN) 202210019513.1

(51) Int. Cl. G06F 3/0484

(52) U.S. Cl. CPC G06F 3/0484; G06F 2203/04803

(57) ABSTRACT

The disclosure provides a method, apparatus, and electronic device for information processing. The method includes: in response to a first trigger operation, obtaining information of at least one team; determining, based on the information of the at least one team, at least one group associated with the team; wherein group information of a group is stored within a predetermined database, the group information comprising group avatar information and other information of the group; presenting team information of the team within a first display area of a first information display interface, the presented team information comprising team avatar information and other information of the team; and presenting first group information of the group associated with the team in a second display area that satisfies a predetermined positional relationship with the first display area of the first information display interface.

### CROSS-REFERENCE TO RELATED APPLICATION

This application claims priority to Chinese patent application No. 202210019513.1, filed on Jan. 7, 2022 and entitled “METHODS, APPARATUS, ELECTRONIC DEVICE AND STORAGE MEDIA FOR INFORMATION PROCESSING”, which is incorporated herein by reference in its entirety.

### FIELD

The present disclosure relates to the field of Internet technology, and in particular, to a method, apparatus, and electronic device for information processing.

### BACKGROUND

With the development of the Internet, users are increasingly using terminal devices to implement various functions.

In some scenarios, users can interact using instant communication applications. Instant communication can refer to a system service used for real-time communication, which allows a plurality of people to use instant communication software to transmit text messages, documents, voice, video, and other information streams in real time.

### SUMMARY

This part of the present disclosure is provided in order to introduce in brief form the ideas which will be described in detailed description section. The present disclosure is not intended to identify key features or essential features of the technical solution for which protection is claimed, nor is it intended to be used to limit the scope of the technical solution for which protection is claimed.

In a first aspect, embodiments of the present disclosure provide a method of information processing, comprising: in response to a first trigger operation, obtaining information of at least one team, a team comprising more than two team members; determining, based on the information of the at least one team, at least one group associated with the team for information exchange among team members of the team, wherein group information of a group is stored within a predetermined database, the group information comprising group avatar information and other information of the group; presenting team information of the team within a first display area of a first information display interface, the presented team information comprising team avatar information and other information of the team; and presenting first group information of the group associated with the team in a second display area that satisfies a predetermined positional relationship with the first display area of the first information display interface, the first group information comprising information other than the group avatar information.

In a second aspect, embodiments of the present disclosure provide a method of information processing, comprising: in response to a predetermined trigger operation, obtaining group information of a group associated with a team, wherein the team comprises more than two team members, and a team is associated with at least one group, the group information of the group being stored within a predetermined database, the group information comprising group avatar information and other information of the group; and presenting, based on a type of a current interface, the group information of the group in the current interface, or presenting first group information of the group in the current interface, wherein the first group information comprises information other than the group avatar information.

In a third aspect, embodiments of the present disclosure provide a method of information processing, comprising: in response to a predetermined trigger operation, obtaining information of a team, wherein the team comprises more than two members, and a team is associated with at least one group, the team information of the team being stored within a first database, and group information of a group associated with the team being stored within a second database; and presenting first information of the team in a specified area of a current interface, wherein the first information of the team comprises at least a part of the team information and a part of the group information, and a content comprised in the first information is related to a type of the current interface.

In a fourth aspect, embodiments of the present disclosure provide an apparatus for information processing, comprising: an obtaining unit configured to, in response to a first trigger operation, obtain information of at least one team, a team comprising more than two team members; a determination unit configured to determine, based on the information of the at least one team, at least one group associated with the team for information exchange among team members of the team, wherein group information of a group is stored within a predetermined database, the group information comprising group avatar information and other information of the group; a display unit configured to present team information of the team within a first display area of a first information display interface, the presented team information comprising team avatar information and other information of the team; and to present first group information of the group associated with the team in a second display area that satisfies a predetermined positional relationship with the first display area of the first information display interface, the first group information comprising information other than the group avatar information.

In a fifth aspect, embodiments of the present disclosure provide an apparatus for information processing, comprising: a first obtaining unit configured to, in response to a predetermined trigger operation, obtain group information of a group associated with a team, wherein the team comprises more than two team members, and a team is associated with at least one group, the group information of the group being stored within a predetermined database, the group information comprising group avatar information and other information of the group; and a first display unit configured to present, based on a type of a current interface, the group information of the group in the current interface, or present first group information of the group in the current interface, wherein the first group information comprises information other than the group avatar information.

In a sixth aspect, embodiments of the present disclosure provide an apparatus for information processing, comprising: a second obtaining unit configured to, in response to a predetermined trigger operation, obtain information of a team, wherein the team comprises more than two members, and a team is associated with at least one group, the team information of the team being stored within a first database, and group information of a group associated with the team being stored within a second database; and a second display unit configured to present first information of the team in a specified area of a current interface, wherein the first information of the team comprises at least a part of the team information and a part of the group information, and a content comprised in the first information is related to a type of the current interface.

In a seventh aspect, embodiments of the present disclosure provide an electronic device, comprising: one or more processors; and a storage device for storing one or more programs, the one or more programs, when executed by the one or more processors, causing the one or more processors to implement the method of the first, second, and third aspects.

In an eighth aspect, embodiments of the present disclosure provide a computer-readable storage medium having a computer program stored thereon, wherein the computer program, when executed by a processor, implements the method of the first, second, and third aspects are implemented.

### BRIEF DESCRIPTION OF THE DRAWINGS

The above and other features, advantages, and aspects of embodiments of the present disclosure will become more apparent with reference to the accompanying drawings and the following specific embodiments. The same reference signs represent the same or similar elements throughout the drawings. It should be understood that the accompanying drawings are merely schematic, and the components or elements are not necessarily drawn to scale.

FIG. 1 is a flowchart of a method of information processing according to an embodiment of the present disclosure;

FIGS. 2A and 2B are schematic diagrams of a method of information processing according to an application scenario of the present disclosure;

FIG. 3 is a schematic diagram of a method of information processing according to an application scenario of the present disclosure;

FIG. 4 is a flowchart of a method of information processing according to yet another embodiment of the present disclosure;

FIG. 5 is a flowchart of a method of information processing according to another embodiment of the present disclosure;

FIG. 6 is a schematic structural diagram of an apparatus for information processing according to an embodiment of the present disclosure;

FIG. 7 is an example system architecture in which a method of information processing of an embodiment of the present disclosure can be applied;

FIG. 8 is a schematic diagram of a basic structure of an electronic device provided according to embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth herein, but rather, these embodiments are provided for a more thorough and complete understanding of the present disclosure. It should be understood that the drawings and the embodiments of the present disclosure are only for illustrative purposes but not intended to limit the protection scope of the present disclosure.

It should be understood that the steps described in the method embodiments of the present disclosure can be executed in a different order and/or performed in parallel. In addition, the method embodiments may comprise additional steps and/or omit execution of the illustrated steps. The scope of the present disclosure is not limited in this regard.

As used herein, the term “comprising” and its variants are open-ended comprising, i.e., “comprising but not limited to”. The term “based on” is “at least partially based on”. The term “one embodiment” means “at least one embodiment”. The term “another embodiment” means “at least one other embodiment”. The term “some embodiments” means “at least some embodiments”. Related definitions of other terms will be given in the following descriptions.

It should be noted that the concepts of “first”, “second” and the like mentioned in the present disclosure are only intended to distinguish different devices, modules, or units, but are not intended to limit the order or interdependence of the functions performed by these devices, modules, or units.

It should be noted that the modifications of “a” and “plurality” mentioned in the present disclosure are schematic rather than limiting, and it should be understood by those skilled in the art that unless otherwise explicitly specified herein, these modifications should be understood as “one or more”.

According to the embodiments of the present disclosure, names of messages or information exchanged between a plurality of devices are used for illustrative purposes only and are not intended to limit the scopes of these messages or information.

In embodiments of the present disclosure, a team uniquely corresponds to a team identifier in the communication system and has an associated set of team members and at least one associated group in the communication system. The communication system herein may be an instant communication software system, in which each team is given a unique team identifier to distinguish it from other entities. For a group associated with a team, its group member set comprises at least some members of the team member set. For example, the group member set can be consistent with the team member set, or the group member set is a proper subset of the team member set. Alternatively, the group member set may also comprise members other than the team member set. In the present disclosure, a group associated with a team may be referred to as a group of the team or may be referred to as a group belonging to the team.

In one embodiment of the present disclosure, a method of information processing is disclosed, and the method comprises:
In Step 1, in response to a predetermined trigger operation, information of a team is obtained, wherein the team comprises more than two members, and a team is associated with at least one group, the team information of the team being stored within a first database, and group information of a group associated with the team being stored within a second database;
In Step 2, first information of the team is presented in a specified area of a current interface, wherein the first information of the team comprises at least a part of the team information and a part of the group information, and a content comprised in the first information is related to a type of the current interface.

The present disclosure provides a new way of information interaction and processing in the above embodiments, comprising determining team information and group information associated with the team. Herein the team information can determine the scope of team members, and the group information can be used for information exchange between the team members, so as to synthesize the two ways of organizing the information, and to ensure that information exchange can be carried out between the team members in the form of groups and the like, as well as to ensure that the scope of information exchange is carried out within the scope of team members, ensuring the security and confidentiality of information interaction. In the case of synthesizing two types of information organization, how to present relevant information so as to reasonably utilize the display space and facilitate the user in capturing important information to improve the information processing efficiency is also a technical problem that needs to be solved. The present embodiment is concerned that the team and the group information associated with the team may appear in different types of display interfaces, and based on the different roles played by different types of display interfaces and the different contents of the information to be presented, the present embodiment distinguishes between the different types of interfaces and makes corresponding adjustments to the information of the team and the group information associated with the team, so as to make the first information of the team presented in the interface match the type of interface, thereby enabling reasonable use of the display space and improving the efficiency of information processing.

In the above embodiments, if the current interface is an interface comprising a mixed information flow display area, presenting first information of the team in a specified area of a current interface comprises: presenting the first information of the team within a mixed information flow area, the first information comprising information of a group associated with the team, the first information comprising a structured identifier with at least one first field; wherein the mixed information flow is used to present team session information and more than one type of non-team session information.

Herein, the structured identifier comprises a session identifier of the group and an identifier of the team to which the group belongs; then the method in the above embodiments further comprises: based on the received first predetermined operation performed on the session identifier of the group, jumping to an information page corresponding to a session identifier of a group where an indication of the first predetermined operation is presented; or, based on the received first predetermined operation performed on the identifier of the team to which the group belongs, jumping to an information page corresponding to a team identifier where an indication of the first predetermined operation is presented.

The mixed information flow may correspond to a specific session filtering tag, and the present operation of the mixed information flow may specifically be an operation of selecting a specific session filtering tag. In some embodies, the specific session filtering tags may be named “message” or “all”. When the specific session filtering tag is selected, the mixed information flow is presented in the session flow display area of the instant communication client interface. For example, if the “Message” filtering tag is currently selected, there are messages that satisfy a predetermined condition in a team group (such as new messages, or messages from @Me or @All). At this time, the team group will appear in the mixed message stream, and its style is different from other ordinary groups. Specifically, its name can comprise two fields, namely group name and team name, respectively. Moreover, these two fields are hot areas and can also be clicked to jump.

Alternatively, in the above embodiments, if the current interface is an interface comprising a team information flow display area, presenting first information of the team in a specified area of a current interface comprises: presenting the first information of the team within a team information flow area, the first information comprising the team information and the information of the group associated with the team; wherein the team information flow is used to present team session information.

Herein, presenting the first information of the team within the team information flow area comprises: presenting, within a first display area of the team information flow area, the team information of the team, the presented team information comprising team avatar information and other information of the team; and presenting first group information of the group associated with the team within a second display area of the team information flow area that satisfies a predetermined positional relationship with the first display area, the first group information comprising information other than group avatar information.

Correspondingly, embodiments of the present disclosure also disclose an apparatus for information processing, comprising:

A second obtaining unit configured to, in response to a predetermined trigger operation, obtain information of a team, wherein the team comprises more than two members, and a team is associated with at least one group, the team information of the team being stored within a first database, and group information of a group associated with the team being stored within a second database.

A second display unit configured to present first information of the team in a specified area of a current interface, wherein the first information of the team comprises at least a part of the team information and a part of the group information, and a content comprised in the first information is related to a type of the current interface.

Herein, the second display unit is configured to, if the current interface is an interface comprising a mixed information flow display area, present the first information of the team within a mixed information flow area, the first information comprising information of a group associated with the team, the first information comprising a structured identifier with at least one first field; wherein the mixed information flow is used to present team session information and more than one type of non-team session information.

Herein, the structured identifier comprises a session identifier of the group and an identifier of the team to which the group belongs; the apparatus also comprises a second processing unit configured to, based on the received first predetermined operation performed on the session identifier of the group, jump to an information page corresponding to a session identifier of a group where an indication of the first predetermined operation is presented; or, based on the received first predetermined operation performed on the identifier of the team to which the group belongs, jump to an information page corresponding to a team identifier where an indication of the first predetermined operation is presented.

Herein, the second display unit is configured to, if the current interface is an interface comprising a team information flow display area, present the first information of the team within a team information flow area, the first information comprising the team information and the information of the group associated with the team; wherein the team information flow is used to present team session information.

Herein, the second display unit is configured to present, within a first display area of the team information flow area, the team information of the team, the presented team information comprising team avatar information and other information of the team; and present first group information of the group associated with the team within a second display area of the team information flow area that satisfies a predetermined positional relationship with the first display area, the first group information comprising information other than group avatar information.

The team information flow is explained below.

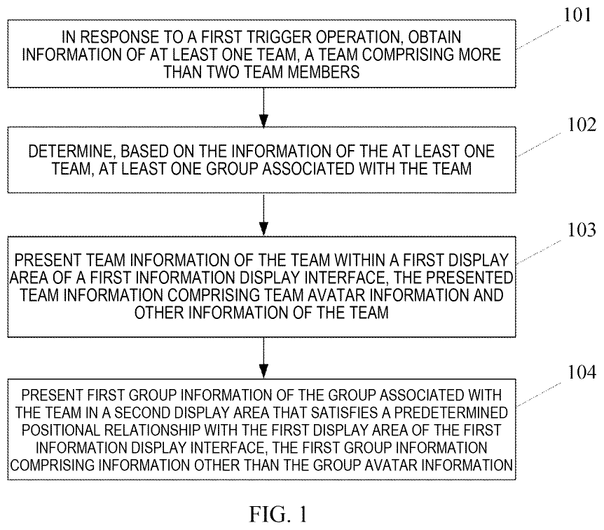

Reference is made to FIG. 1, which shows a flow of a method of information processing according to an embodiment of the present disclosure. The method of information processing is applied to a terminal device. As shown in FIG. 1, the method of information processing comprises the following steps:

In Step 101, in response to a first trigger operation, information of at least one team is obtained. A team comprises more than two team members.

In this embodiment, the execution subject of the method of information processing (such as a terminal device) can obtain the information of at least one team in response to a predetermined trigger operation.

Herein, a team uniquely corresponds to a team identifier in the communication system and has an associated set of team members and at least one associated group in the communication system. For a group associated with a team, its group member set comprises at least some members of the team member set.

In this embodiment, the above execution subject obtains the information of the team that the current user has joined from the server. The information of a team comprises at least one of the following but is not limited to: the name of the team, avatar, team ID, team member information, and group information associated with the team.

In this embodiment, the execution subject can also obtain the information of at least one of the above teams locally from the client (previously obtained from the server and cached locally).

Herein, the current user may join one or more teams.

In this embodiment, the operation type of the above-mentioned first trigger operation can be set according to the actual application field. The user can click the predetermined control to implement the predetermined trigger operation. For example, the predetermined trigger operation comprises: an operation of selecting a team filtering tag.

In Step 102, based on the information of the at least one team, at least one group associated with the team for information exchange among team members of the team is determined, wherein group information of a group is stored within a predetermined database. The group information comprises group avatar information and other information of the group.

In Step 103, team information of the team is presented within a first display area of a first information display interface. The presented team information comprises team avatar information and other information of the team.

In Step 104, first group information of the group associated with the team is presented in a second display area that satisfies a predetermined positional relationship with the first display area of the first information display interface. The first group information comprises information other than the group avatar information.

The present disclosure provides a new way of information interaction and processing in the above embodiments, comprising determining team information and group information associated with the team. Herein the team information can determine the scope of team members, and the group information can be used for information exchange between the team members, so as to synthesize the two ways of organizing the information, and to ensure that information exchange can be carried out between the team members in the form of groups and the like, as well as to ensure that the scope of information exchange is carried out within the scope of team members, ensuring the security and confidentiality of information interaction. In the case of synthesizing two types of information organization, how to present relevant information so as to reasonably utilize the display space and facilitate the user in capturing important information to improve the information processing efficiency is also a technical problem that needs to be solved. In the present disclosure, when presenting team information and group information associated with a team in the first information display interface, by selecting only the other information of the group from the group avatar information and other information of the group as the display content without displaying the avatar information of the group, and by displaying the avatar information of the team and the other information of the team when displaying the team information, it is possible to utilize the display space in a more compact manner. Moreover, by team avatar identifiers, it is easy to distinguish between different teams, and by not displaying group avatars, it is also possible to avoid group avatars from interfering with the user and making it difficult for the user to distinguish from which team the message is from, thereby improving the utilization of the present space and the efficiency of the processing of the information.

In some embodiments, the first information display interface is a session flow area in a communication client interface.

In some embodiments, the first display area comprises a team avatar display area and a team other information display area; the second display area comprises at least one sub-display area each for presenting first group information of a group.

In this embodiment, for a team, a position of the second display area is determined based on a display position of a team avatar within the first display area or a display position of other information of the team, a display position of the first group information being presented with an indentation relative to the display position of the team avatar.

In some embodiments, for a team, the corresponding contents in the first display area and the second display area form a “team-group” index structure for team-based indexing. Groups within teams. Optionally, the index structure may comprise at least one of, but not limited to, the following: a type of information to be presented, a layout of the information to be presented, a size of the information to be presented, and the like. Optionally, the type of information to be presented may comprise at least one of, but is not limited to: team information, group information, a control for collapsing groups in a team, a control for expanding a group in a team.

In this embodiment, the execution subject of the method of information processing (such as a terminal device) can present the information of at least one team in the session list (i.e., the session flow area) based on the index structure of the at least one team.

In this embodiment, the session list can be used to present session information. The session corresponding to the session information can have various organizational forms, such as a one-to-one session, a group session of at least three people, or a team comprising a plurality of groups. In some embodiments, the session list refers to the main session flow display area in the communication client interface.

In one embodiment of the present invention, the group refers to a group chat. The team corresponds to a group of people specified in the communication system, called team members. The members of the group of the team are a subset of the team members. For example, if there are 120 people participating in Project A, you can create a team with these 120 people as team members, and a plurality of groups can be created for the team. For example, 25 of the PMs (Product Managers) create a PM group for the group members, 95 of the R&D personnel create an R&D group for the group members, and all 120 people can also create an all-member communication group.

In this embodiment, team information can be presented in the session list, and the number of presented teams can be one or at least two.

In this embodiment, a team can comprise at least one group. The information of the team may comprise team information and group information of groups comprised in the team. The group information presented in the team information may be one or at least two.

In this embodiment, team information can be used to indicate team-related information. The team information comprises a team avatar.

In this embodiment, group information can be used to indicate group-related information. Herein, group avatars are excluded from the group information.

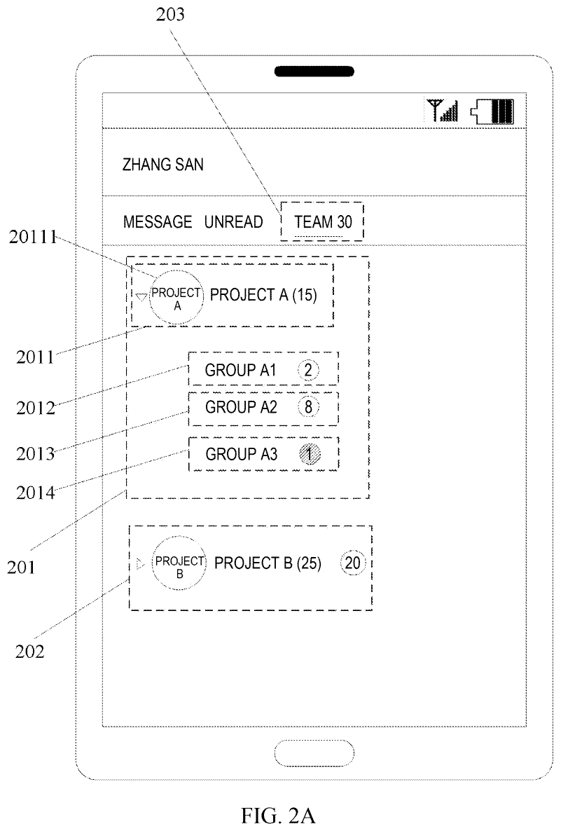

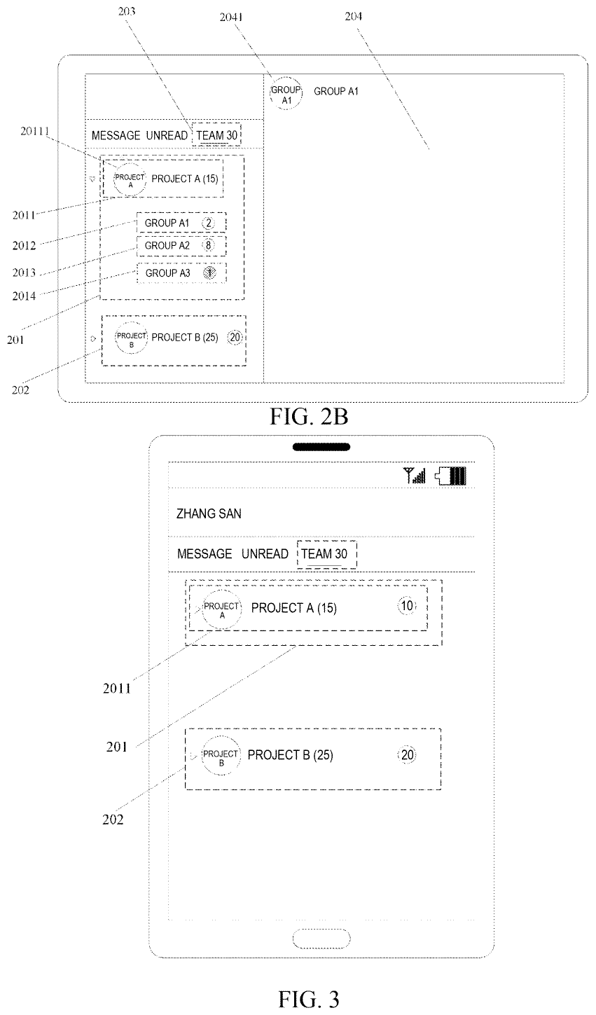

Reference is made to FIG. 2A, where FIGS. 2A and 2B show the application scenarios corresponding to the embodiments in FIG. 1. Herein, FIG. 2A is a schematic diagram of an interface of a mobile terminal, and FIG. 2B is a schematic diagram of an interface of a PC terminal. The following takes FIG. 2A as an example for introduction. To understand FIG. 2B, reference is made to the relevant introduction of FIG. 2A.

In FIG. 2A, information 201 of the team corresponding to project A and information 202 of the team corresponding to project B are shown. In the information 201 of the team, team information 2011, group information 2012 corresponding to group A1, group information 2013 corresponding to group A2, and group information 2014 corresponding to group A3 are shown. The team avatar 20111 of the team information is shown. In the information 201 of the team, the group information 2012 corresponding to group A1, the group information 2013 corresponding to group A2, and the group information 2014 corresponding to group A3 do not have their group avatars present.

Optionally, in scenarios other than the scenario where the team information flow is presented in the session list (such as the session list scenario when the team filtering tag is selected as shown in FIGS. 2A and 2B), when presenting the group, the group avatar for the group can be presented. As an example, reference is made to FIG. 2B, which shows that after the user selects group information 2012, the session details of the selected group are presented in the group session area 204, i.e., the corresponding information of group A1 is presented in the group session area. At this time, the group avatar 2041 corresponding to group A1 is presented in the group session area. In addition, group avatars can be presented in mixed information flow scenarios (session list scenarios when the “Message” or “All” filtering tag is selected), group cards inserted in documents, and other scenarios.

Optionally, the team information can also comprise the number of team members. Reference is made to FIG. 2A. The 15 in the team information 2011 in FIG. 2A can indicate that the number of team members of the team corresponding to Project A is 15. The 25 in the information 202 for the corresponding team of Team B in FIG. 2A can indicate that the number of team members of team B is 25.

It should be noted that the method of information processing provided by this embodiment, in response to a first trigger operation, obtains information of at least one team, a team comprising more than two team members; determines, based on the information of the at least one team, at least one group associated with the team for information exchange among team members of the team, wherein group information of a group is stored within a predetermined database, the group information comprising group avatar information and other information of the group; presents team information of the team within a first display area of a first information display interface, the presented team information comprising team avatar information and other information of the team; and presents first group information of the group associated with the team in a second display area that satisfies a predetermined positional relationship with the first display area of the first information display interface, the first group information comprising information other than the group avatar information. Thus, the interface area occupied by group information can be reduced, the interface utilization rate of the session interface can be improved, and the simplicity of the session interface can be improved. Specifically, if the group information of the group belonging to the team is presented in the team information, and the group avatar is excluded from the group information, the height of the row where the group information is located can be reduced, so that the structure of the session information in the session interface is more efficient and the information is more focused.

In some embodiments, the predetermined trigger operation comprises: an operation of selecting the team filtering tag. In other words, when the team filtering tag is selected, information of at least one team is presented in the session list.

Reference is made to FIG. 2A, which illustrates a team filtering tag 203. When the team filtering tag 203 is selected, the team filtering tag may comprise an identifier used to distinguish it from the unselected state, such as a horizontal line under the word “Team”. When the team filtering tag is selected, the information of at least one team can be presented in the session list, such as the information 201 of the team corresponding to project A and the information 202 of the team corresponding to project B shown in FIG. 2A. It should be noted that in FIG. 2A, in order to clearly illustrate the scope of the relevant information, parts corresponding to different reference numbers are circled with a dotted line frame. The dotted line frame itself is not the content presented on the IM interface.

Optionally, in FIG. 2A, other filtering tags are also shown. For example, the filtering tag corresponding to “Message” can be used to present the session flow with new messages (also called mixed information flow in this article), “Unread” The corresponding filtering tag can be used to present session streams with unread messages.

For the session list of the instant communication application, when the team filtering tag is selected, the group information for the team excluding the group avatar can be presented in the corresponding session flow area. As a result, the group avatar can not be presented on the page corresponding to the team filtering tag, which can reduce the height of the group information, making the entire “team-group” index structure present more efficient and the information more focused.

In some embodiments, the method further comprises: presenting a first number of messages in a display area of the team filtering tag, the first number being acquired based on the number of messages of a second predetermined type of messages in a first predetermined type of groups for all teams.

Herein, the first predetermined type of group comprises all groups, or comprises groups with a message reminder turned on, or groups that comprise messages mentioning users (such as @me messages or @all messages); the second predetermined type of messages comprise unread messages, or messages mentioning a predetermined user (such as @me messages or @all messages).

In some embodiments, the team filtering tag presents the number of unread messages in groups for all teams; or presents the number of unread messages in groups with message reminders turned on for all teams.

Reference is made to FIG. 2A. In the team filtering tag 203 shown in FIG. 2A, the number of unread messages 30 is presented; the number of unread messages 30 presented may be the sum of the number of unread messages (e.g., 10) of the groups in Project Team A with a message reminder turned on (e.g., comprising group A1 and group A2) and the number of unread messages (e.g., 20) of the groups in Project Team B with a message reminder turned on. Herein, group A3 have turned off message reminders (The number of unread messages with a message reminder turned off can be grayed out. For example, the number of unread messages 1 corresponding to group A3 in FIG. 2A is shaded to indicate that it is grayed out.) Therefore the number of unread messages for the team corresponding to project A presented does not comprise the number of unread messages for group A3. Optionally, the number of unread messages presented may also be the number of unread messages in all the groups in the team, such as the sum of the number of unread messages in all the groups in the team corresponding to project A and the number of unread messages in all the groups in the team corresponding to project B.

Therefore, regardless of whether the team filtering tag is selected, the user can be prompted with the number of unread messages of the team in the team filtering tag. Further, the user is provided with the basis for selecting the team filtering tag, presenting the sessions under the team in the session flow area, and then processing the team messages.

In some embodiments, the team presented in the first information display interface to which they belong has an expanded state and a collapsed state; wherein the above method also comprises: in response to a collapsing operation on the team, presenting team information of a team in the first information display interface and hiding first group information of a group associated with the team; and in response to an expanding operation on the team, presenting team information of a team and first group information of each group associated with the team in the first information display interface.

Reference is made to FIG. 2A. The information 201 of the team corresponding to Project A shown in FIG. 2A is in an expanded state; the information 201 of the team corresponding to Project A shown in FIG. 3 is in a collapsed state.

Reference is made to FIG. 3 for the information 201 of the team in the collapsed state. The information 201 of the team corresponding to project A only presents the team information 2011, but does not present the group information in the team corresponding to project A.

For the information 201 of the team in the expanded state, reference is made to FIG. 2A. In the information 201 of the team corresponding to project A, the information 201 of the team and the group information for the team can be presented, for example, the group information 2012 corresponding to group A1, group information 2013 corresponding to group A2 and group information 2014 corresponding to group A3.

Therefore, in the expanded state, the group information of the team is presented, and the user can perform operation on the group in the team; in the collapsed state, the team information of the team is presented without presenting the group information, which can reduce the interface area occupied by the information of a single team, present the information of more teams in the session flow area, and improve the speed of the user to find the desired team.

In some embodies, if information of a team is in an expanded state, the number of unread messages is excluded from the presented team information. Reference is made to FIG. 2A. The information 201 of the team corresponding to Project A is in an expanded state. In the information 201 of the team in FIG. 2A, the number of unread messages is not presented.

In some embodiments, if information of a team is in an expanded state, the first group information presented for the groups associated with the team comprises the total number of unread messages for the group.

In some embodies, when information of a team is in a collapsed state, the team information presented comprises: the total number of unread messages in the group of the team, or the unclosed message reminder for the team The total number of unread messages in the group. Reference is made to FIG. 3. The information 201 of the team corresponding to Project A is in a collapsed state. In the information 201 of the team in FIG. 3, the number of unread messages can be presented; this number of unread messages may be the number of unread messages 11 of the group of the team corresponding to project A, or the number of unread messages 10 in the group with message reminders turned on of the team corresponding to project A. As well as referring to the team corresponding to project B in FIG. 2A, the information 202 of the team corresponding to project B is in the collapsed state, and the number of unread messages 20 may be presented in the information 202 of the team in FIG. 2A; This number of unread messages may be a total number of unread messages in the group of the team corresponding to project B, or a total number of unread messages in the group under the team corresponding to the project with message reminders turned on.

As a result, not only can it be ensured that the number of unread messages can be presented regardless of whether it is in the expanded or collapsed state; moreover, it is possible to reduce the display content of team information in the expanded state and reduce information redundancy in the interface. Specifically, if the number of unread messages has been presented in the group information, the information with a certain repetition of meaning (the number of unread messages of the team is the sum of the number of unread messages of the group) is no longer presented in the team information, i.e., the number of unread messages is not presented in the team information. In some embodiments, in response to a trigger operation for a team presented in the session list, a display state of the team is switched, the display state comprising an expanded state and a collapsed state.

In the embodiments of the present disclosure, a state switching control is presented in the first display area; in response to the state switching control of the team being triggered, the present state of the team is switched; wherein, the information of a team is in different present statuses., the present form of the state switching control of the team is also different.

Reference is made to FIG. 2A. In FIG. 2A, click on the triangle on the left side of team avatar 20111 to switch the display state of the information of the team to the collapsed state shown in FIG. 3; in FIG. 3, click on the triangle on the left side of team avatar 20111 to switch the display state of the information of the team to the expanded state shown in FIG. 2A.

Optionally, for the trigger operation performed on the team presented, in addition to the method of clicking the predetermined control indicated by the triangle shown in FIG. 2A and FIG. 3, other methods can also be set according to the actual application scenario, which are not limited here.

This allows quick switching of the present state of team information.

In some embodiments, the group information comprises at least one of: a group name, the number of unread messages in a group, and the number of members in the group.

As an example, reference is made to FIG. 2A. FIG. 2A shows group information 2012 corresponding to group A1. “Group A1” in the group information 2012 is the group name, and “2” in the group information 2012 is the number of unread messages of the group. FIG. 2A shows the group number of group information 2013 is “1”, and because the message reminder has been turned off for group A3, the number of unread messages is shaded to indicate that the number of unread messages is greyed out and does not participate in the calculation of the number of unread messages for the team.

In some embodiments, the method further comprises: if a new group belonging to the team is created in a group creation page of the team, generating a group avatar of the new group based on a group name of the new group, or based on a group avatar setting operation of a user; and if an existing group is added to the team, remaining an original group avatar of the existing group unchanged, or generating a group avatar of the existing group based on a group avatar setting operation of the user.

As an example, the group name of the new group can be used as the main image of the group avatar.

This makes it easier for users to understand the purpose of the new group.

In some embodiments, the method further comprises: when a new group belonging to the team is created in the group creation page of the team, generating a group avatar of the existing group based on a group avatar setting operation of a user.

As an example, the user can select a desired image as the group avatar through the group avatar setting operation.

In some embodiments, the method further comprises: if an existing group is added to the team, remaining an original group avatar of the existing group unchanged, i.e., keeping the original group avatar of the existing group unchanged. Alternatively, the group avatar of the existing group can also be generated based on the group avatar setting operation by the used. In this way, the user can be provided with group avatars that the user is already familiar with, so that the user has a consistent understanding of the existing group, and the possibility of user misoperation is reduced.

Herein, adding an existing group to a team refers to establish an association between the existing group and the team, for example, making the existing group belong to the team, which is not limited here.

In some embodiments, the above method of information processing further comprises: in response to an operation of presenting a second information interface, presenting group avatar information of the group associated with the team within a specified area in the second information interface. Herein, the second information interface comprises one or more of the following:
a session flow area, if a filtering tag other than a team filtering tag is selected;
a session details interface for the group associated with the team; or
an interface presenting a group card of the group associated with the team.

In some embodiments of the present disclosure, the avatar of the team group is hidden in the scene where team information is presented, but in the second scene other than presenting the team information flow (such as mixed information flow scene, group session interface, group card, etc.), when presenting the group information of a group of the team, the group avatar of the group is presented.

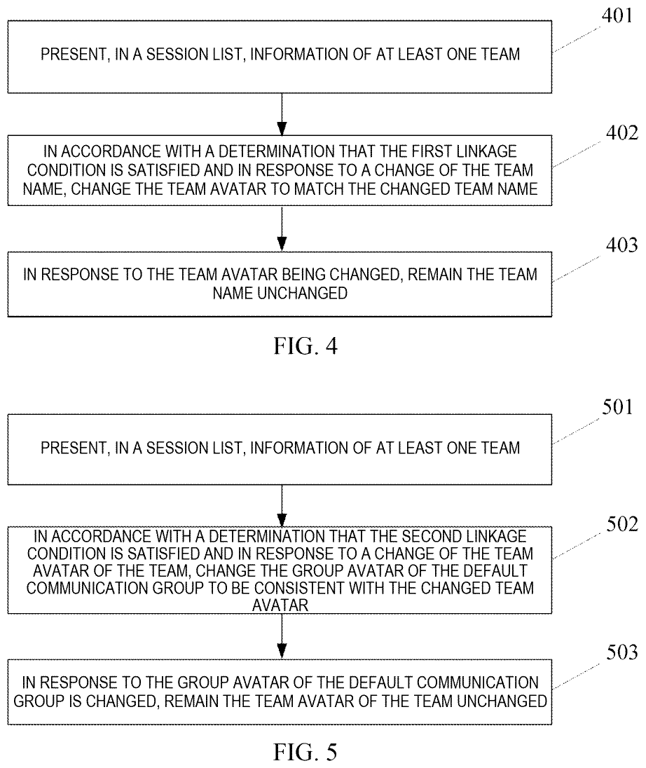

Reference is made to FIG. 4, which shows a flow of a method of information processing according to the present disclosure. As shown in FIG. 4, the method of information processing comprises the following steps:

In Step 401, information of at least one team is presented in the session list.

In this embodiment, the execution subject of the method of information processing (such as a terminal device) can present the information of at least one team in the session list.

Herein, the information of a team may comprise: team information and at least one group information; wherein the team information comprises a team avatar, and a group avatar is excluded from the group information.

For the implementation details and technical effects of Step 401, reference is made to the description of Step 101 in this application, which will not be described again here.

In some embodiments, in accordance with a determination that a first linkage condition is satisfied, the team avatar matches a team name of the team.

Herein, the first linkage condition indicates a condition in which the team avatar changes along with the team name. The specific content of the first linkage condition can be set according to the actual application scenario.

In some embodiments, the first linkage condition comprises that the team avatar remains unedited by a user before a current point of time.

As an example, if the user has edited the team avatar once or at least twice, it is determined that the first linkage condition is not satisfied. If the first linkage condition is not satisfied and the user edits the team name, the team avatar will not change along with the team name.

Therefore, after the user edits the team avatar at least once, the team avatar will no longer change with the team name. It can be ensured that the team avatar meets user expectation and the team avatar set by the user will not be changed due to changes in the team name.

In some embodiments, the team avatar matching a team name comprises presenting all or part of the team name in the team avatar.

In Step 402, in accordance with a determination that the first linkage condition is satisfied and in response to a change of the team name, the team avatar is changed to match the changed team name.

As an example, if the team name corresponding to Project A shown in FIG. 2A is changed from Project A to Project C, then if the first linkage condition is satisfied, the words Project C will also be presented in the avatar in the team information.

In Step 403, in response to the team avatar being changed, the team name remains unchanged.

In the method shown in FIG. 4, Step 402 and Step 403 can be executed either one or both.

As an example, for the team corresponding to project A shown in FIG. 2A, if the first linkage condition is satisfied, and the user changes the team avatar in the team information, the team name corresponding to project A remains unchanged, i.e., the name of the team present after the team avatar in the team information is still “project A”.

It should be noted that in the embodiments corresponding to FIG. 4, the team avatar and the team name are linked, i.e., if the first linkage condition is satisfied, when the user inputs the team name, it will be reflected on the team avatar simultaneously, increasing the differentiation of the team, so that team members can quickly recognize the team and understand its core purpose. Moreover, when users edit the team avatar and the team name remains unchanged with the team avatar, it can be ensured that the team avatar does not affect user understanding of the core purpose of the team.

Reference is made to FIG. 5, which shows a flow of a method of information processing according to another embodiment of the present disclosure. As shown in FIG. 5, the method of information processing comprises the following steps:

In Step 501, information of at least one team is presented in the session list.

In this embodiment, the execution subject of the method of information processing (such as a terminal device) can present the information of at least one team in the session list.

Herein, the information of a team may comprise: team information and at least one group information; wherein the team information comprises a team avatar, and a group avatar is excluded from the group information.

For the implementation details and technical effects of Step 501, reference is made to the description of Step 101 in this application, which will not be described again here.

In some embodiments, in accordance with a determination that a second linkage condition is satisfied, a group avatar of a default communication group of the team is consistent with the team avatar of the team.

Optionally, the group members of the default communication group can be consistent with the team members of the team. The default communication group can be understood as a basic group of the team.

Optionally, the two avatars are consistent, which may comprise at least partial similarity. As an example, at least part of the same may comprise being completely identical and may also comprise the same main content.

Herein, the second linkage condition indicates a condition in which the group avatar of the default communication group changes along with the team avatar before a current point of time.

In some embodiments, the second linkage condition comprises that the group avatar of the default communication group remaining unedited by a user.

As an example, if the user has edited the group avatar of the default communication group once or at least twice, then it is determined that the second linkage condition is not satisfied. When the second linkage condition is not satisfied and the user edits the team avatar, the group avatar of the default communication group remains unchanged with the team name.

Therefore, after the user edits the group avatar of the default communication group at least once, the group avatar of the default communication group will no longer change along with the team avatar. It can be ensured that the group avatar of the default communication group satisfies user expectation and will not change the group avatar of the default communication group set by the user due to the change of the team avatar.

In Step 502, in accordance with a determination that the second linkage condition is satisfied and in response to a change of the team avatar of the team, the group avatar of the default communication group is changed to be consistent with the changed team avatar.

As an example, group A1 in project team A is a default communication group of project team A. If the second linkage condition is satisfied and the team avatar of project team A changes, the group avatar of group A1 will also changes to the changed team avatar of project team A.

In Step 503. in response to the group avatar of the default communication group is changed, the team avatar of the team remains unchanged.

In the method shown in FIG. 5, step 502 and step 503 can be executed either one or both.

As an example, group A1 in project team A is a default communication group of project team A. If the second linkage condition is satisfied and the group avatar of group A1 changes, the team avatar of project team A will not change.

It should be noted that in the embodiment corresponding to FIG. 5, the group avatar of the default communication group in the team is linked with the team avatar, i.e., if the second linkage condition is satisfied, it is synchronously reflected in the group avatar of the default communication group in the team when the user edits the team avatar, increasing the consistency between the default communication group and the team, enabling the team members to quickly determine the default communication group among a plurality of groups in the team, and understand the default communication group's position in the team (i.e., the base group). Moreover, users edit the group avatar, and the team avatar does not change with the group avatar, which ensures that the group avatar of the default communication group does not affect the user's understanding of the team and ensures that users can accurately identify the team.

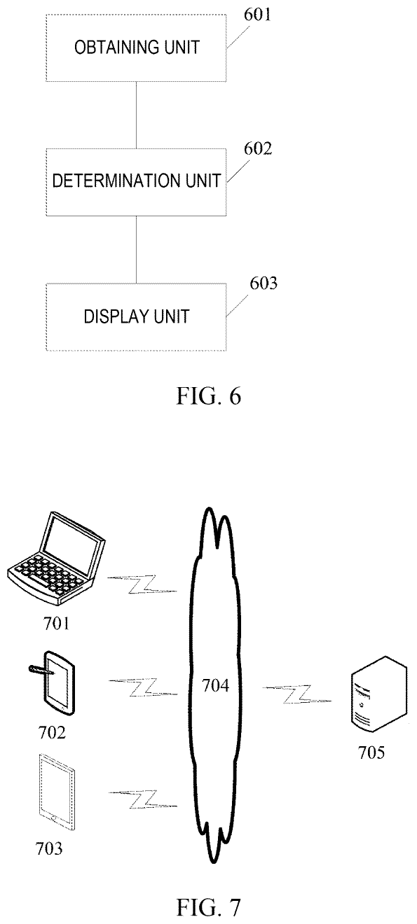

With further reference to FIG. 6, as an implementation of the methods shown in the above figures, the present disclosure provides an embodiment of an apparatus for information processing. The apparatus embodiments correspond to the method embodiments shown in FIG. 1. The apparatus can be applied to various applications. in electronic device.

As shown in FIG. 6, the apparatus for information processing of this embodiment comprises: an obtaining unit 601, a determination unit 602 and a display unit 603. Herein, the obtaining unit 601 is configured to, in response to a first trigger operation, obtain information of at least one team, a team comprising more than two team members; the determination unit 602 is configured to determine, based on the information of the at least one team, at least one group associated with the team for information exchange among team members of the team, wherein group information of a group is stored within a predetermined database, the group information comprising group avatar information and other information of the group; the display unit 603 is configured to present team information of the team within a first display area of a first information display interface, the presented team information comprising team avatar information and other information of the team; and to present first group information of the group associated with the team in a second display area that satisfies a predetermined positional relationship with the first display area of the first information display interface, the first group information comprising information other than the group avatar information.

In this embodiment, the specific processing of the obtaining unit 601, the determination unit 602 and the display unit 603 of the apparatus for information processing and the technical effects thereof can be referred to the relevant descriptions of steps 101, 102 and 103 in the corresponding embodiments in FIG. 1 respectively, which will not be described in detail here.

In some embodiments, the first display area comprises a team avatar display area and a team other information display area; and/or, the second display area comprises at least one sub-display area each for presenting first group information of a group.

In some embodiments, the display unit 603 is configured to, for a team, determine a position of the second display area based on a display position of a team avatar within the first display area or a display position of other information of the team, a display position of the first group information being presented with an indentation relative to the display position of the team avatar.

In some embodiments, the first trigger operation comprises: a selection operation on a team filtering tag.

In some embodiments, the display unit 603 is further configured to present a first number of messages in a display area of the team filtering tag, the first number being acquired based on the number of messages of a second predetermined type of messages in a first predetermined type of groups for all teams.

Herein, the first predetermined type of groups comprises all groups, or comprises groups with a message reminder turned on; and the second predetermined type of messages comprise unread messages, or messages mentioning a predetermined user.

In some embodiments, the first information display interface is a session flow area in a communication client interface.

Herein, the team presented in the first information display interface has an expanded state and a collapsed state; the apparatus for information processing is also used to, in response to a collapsing operation on the team, present team information of a team in the first information display interface and hide first group information of a group associated with the team; in response to an expanding operation on the team, present team information of a team and first group information of each group associated with the team in the first information display interface.

In some embodiments, the display unit 603 is further configured to present a state switching control within the first display area; and in response to the state switching control of the team being triggered, switch a display state of the team; wherein a present form of the state switching control of the team is different if information of a team is in a different display state.

Herein, if information of a team is in an expanded state, the number of unread messages is excluded from the presented team information; or, if information of a team is in a collapsed state, the presented team information of the team comprises: a total number of unread messages in groups of the team, or a total number of unread messages in a group of the team with a message reminder turned on.

Herein if information of a team is in an expanded state, presented first group information of a group associated with the team comprises a total number of unread messages of the group.

Herein the first group information comprises at least one of: a group name, the number of unread messages in a group, and the number of members in the group.

Herein, in accordance with a determination that a first linkage condition is satisfied, the team avatar matches a team name of the team, wherein the first linkage condition indicates a condition in which the team avatar changes along with the team name.

Herein, t the team avatar matching a team name comprises presenting all or part of the team name in the team avatar.

In some embodiments, the apparatus for information processing is further used to: in accordance with a determination that the first linkage condition is satisfied and in response to a change of the team name, change the team avatar to match the changed team name; and/or, in response to the team avatar being changed, remain the team name unchanged.

Herein, the first linkage condition comprises: the team avatar remaining unedited by a user before a current point of time.

In some embodiments, in accordance with a determination that a second linkage condition is satisfied, a group avatar of a default communication group of the team is consistent with the team avatar of the team, wherein the second linkage condition indicates a condition in which the group avatar of the default communication group changes along with the team avatar.

In some embodiments, the apparatus for information processing is also used to: in accordance with a determination that the second linkage condition is satisfied and in response to a change of the team avatar of the team, change the group avatar of the default communication group to be consistent with the changed team avatar; and/or, in response to the group avatar of the default communication group is changed, remain the team avatar of the team unchanged.

Herein, the second linkage condition comprises: the group avatar of the default communication group remaining unedited by a user before a current point of time.

In some embodiments, the apparatus for information processing is also used to perform one or more of the following:
if a new group belonging to the team is created in a group creation page of the team, generating a group avatar of the new group based on a group name of the new group, or based on a group avatar setting operation of a user; and
if an existing group is added to the team, remaining an original group avatar of the existing group unchanged, or generating a group avatar of the existing group based on a group avatar setting operation of the user.

In some embodiments, the apparatus for information processing is further used to perform: in response to an operation of presenting a second information interface, presenting group avatar information of the group associated with the team within a specified area in the second information interface. Herein, the second information interface comprises one or more of the following:
a session flow area, if a filtering tag other than a team filtering tag is selected;
a session details interface for the group associated with the team; or
an interface presenting a group card of the group associated with the team.

The present disclosure also provides a method of information processing, comprising:
Step A in response to a predetermined trigger operation, obtaining group information of a group associated with a team, wherein the team comprises more than two team members, and a team is associated with at least one group, the group information of the group being stored within a predetermined database, the group information comprising group avatar information and other information of the group.
Step B: presenting, based on a type of a current interface, the group information of the group in the current interface, or presenting first group information of the group in the current interface, wherein the first group information comprises information other than the group avatar information.

In this embodiment, when a group is associated with a team, the group itself may appear in different types of display interfaces, this embodiment distinguishes between different types of display interfaces, and matches the group information presented with the type of display interface, presenting group avatar information and other group information in some interfaces, and presenting only other group information in other interfaces, so as to make rational use of the display space in the corresponding type of interface, and improve the efficiency of information processing in the corresponding type of interface, avoiding interference with users' access to information or location information due to the presenting of group avatars in some interfaces, and avoiding interference with users' access to information or location information due to the absence of group avatars in other interfaces, as well as avoiding the lack of information in other interfaces, in order to avoid the lack of information in other interfaces and to avoid the lack of information in other interfaces.

For example, by presenting information other than group avatars in a group message in the session flow area presented after the team filtering tag is selected (i.e., when the team filtering tag is selected), it is possible to avoid displaying too many group avatars in the team's session flow area, avoiding too many group avatars from interfering with the user and making it difficult for users to distinguish which team the message is from, and thus improving the utilization of the display space. For example, presenting the group avatar information in the mixed message flow display area, or in the session details page, or in the group card, can facilitate the user to locate which group the group is, avoiding misidentifying the group or spending too much time locating the group.

Further, the method comprises at least one of the following:
if the current interface is a session flow area presented after a team filtering tag is selected in a communication client, presenting the first group information of the group in the current interface;
if the current interface is a session flow area presented after a filtering tag other than the team filtering tag is selected in the communication client, presenting the group information of the group in the current interface;
if the current interface is a session details interface of the group, presenting the group information of the group in the current interface; or
   if the current interface is an interface presenting a group card of the group, presenting the group information of the group in the current interface.

Herein, the predetermined trigger operation comprises at least one of:
an operation of selecting the team filtering tag;
an operation of selecting a filtering tag other than the team filtering tag;
an operation of entering a session details page of the group; or
an operation of sending a message satisfying a predetermined condition in the group associated with the team.

Correspondingly, the present disclosure also provides an apparatus for information processing, comprising:
a first obtaining unit configured to, in response to a predetermined trigger operation, obtain group information of a group associated with a team, wherein the team comprises more than two team members, and a team is associated with at least one group, the group information of the group being stored within a predetermined database, the group information comprising group avatar information and other information of the group; and
a first display unit configured to present, based on a type of a current interface, the group information of the group in the current interface, or present first group information of the group in the current interface, wherein the first group information comprises information other than the group avatar information.

In some embodiments, the apparatus is used to perform at least one of the following:
if the current interface is a session flow area presented after a team filtering tag is selected in a communication client, presenting the first group information of the group in the current interface;
if the current interface is a session flow area presented after a filtering tag other than the team filtering tag is selected in the communication client, presenting the group information of the group in the current interface;
if the current interface is a session details interface of the group, presenting the group information of the group in the current interface; or
if the current interface is an interface presenting a group card of the group, presenting the group information of the group in the current interface.

Herein, the predetermined trigger operation comprises at least one of:
an operation of selecting the team filtering tag;
an operation of selecting a filtering tag other than the team filtering tag;
an operation of entering a session details page of the group; or
an operation of sending a message satisfying a predetermined condition in the group associated with the team.

Reference is made to FIG. 7, which shows an example system architecture in which a method of information processing of an embodiment of the present disclosure can be applied.

As shown in FIG. 7, the system architecture may comprise terminal devices 701, 702, 703, a network 704, and a server 705. The network 704 is a medium used to provide communication links between terminal devices 701, 702, 703 and the server 705. The network 704 may comprise various connection types, such as wired, wireless communication links, or fiber optic cables, among others.

The terminal devices 701, 702, 703 can interact with the server 705 through the network 704 to receive or send messages, etc. Various client applications can be installed on the terminal devices 701, 702, and 703, such as web browser applications, search applications, and news information applications. The client applications in the terminal devices 701, 702, and 703 can receive the user's instructions and complete corresponding functions according to the user's instructions, such as adding corresponding information to the information according to the user's instructions.

The terminal devices 701, 702, and 703 may be hardware or software. When the terminal devices 701, 702, and 703 are hardware, they can be various electronic devices with display screens and supporting web browsing, comprising but not limited to smartphones, tablet computers, e-book readers, and M MP3 players (Moving Picture Experts Group Audio Layer III), MP4 (Moving Picture Experts Group Audio Layer IV) players, laptop, and desktop computers, and the like. When the terminal devices 701, 702, and 703 are software, they can be installed in the electronic devices listed above. It can be implemented as a plurality of software or software modules (such as software or software modules used to provide distributed services), or as a single software or software module. There are no specific limitations here.

The server 705 may be a server that provides various services, such as receiving information obtaining requests sent by the terminal devices 701, 702, and 703, and obtaining display information corresponding to the information obtaining requests in various ways based on the information obtaining requests. And the relevant data of the display information is sent to the terminal devices 701, 702, and 703.

It should be noted that the method of information processing provided by the embodiments of the present disclosure can be executed by a terminal device. Accordingly, the apparatus for information processing can be provided in the terminal devices 701, 702, and 703. In addition, the method of information processing provided by the embodiments of the present disclosure can also be executed by the server 705, and accordingly, the apparatus for information processing can be provided in the server 705.

It should be understood that the number of terminal devices, networks, and servers in FIG. 7 is only illustrative. Depending on implementation needs, there can be any number of end devices, networks, and servers.

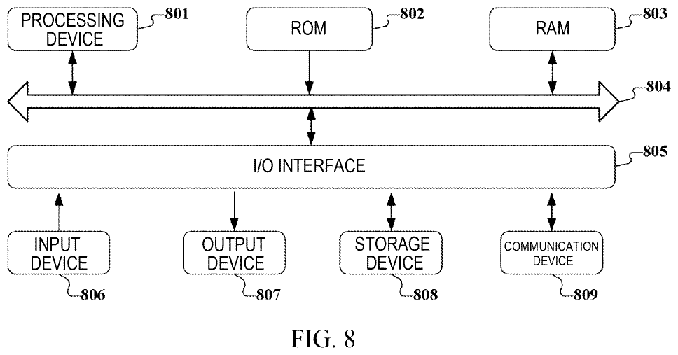

Reference is made below to FIG. 8, which is a schematic structural diagram of an electronic device 800 suitable for implementing the embodiments of the present disclosure. According to an embodiment of the present disclosure, a terminal device may comprise, but is not limited to, mobile terminals such as a mobile phone, a notebook computer, a digital broadcast receiver, a personal digital assistant (PDA), a tablet PC (PAD), a portable multimedia player (PMP) and a vehicle-mounted terminal (for example, a vehicle-mounted navigation terminal), and fixed terminals such as a digital TV and a desktop computer. The electronic device shown in FIG. 8 is merely an example and should not impose any limitation on the function or the scope of application of the embodiments of the present disclosure.

As shown in FIG. 8, the electronic device 800 may comprise a processing device (such as a central processing unit and a graphics processing unit) 801 which may execute various appropriate actions and processing according to a program stored in a read-only memory (ROM) 802 or a program loaded from a storage device 808 to a random-access memory (RAM) 803. Various programs and data required during operation of the electronic device 800 are also stored in the RAM 803. The processing device 801, the ROM 802 and the RAM 803 are connected with one another via a bus 804. An input/output (I/O) interface 805 is also connected to the bus 804.

Generally, the following devices may be connected to the I/O interface 805: an input device 806 comprising a touch screen, a touch pad, a keyboard, a mouse, a camera, a microphone, an accelerometer, a gyroscope and the like, for example; an output device 807 comprising a liquid crystal display (LCD), a speaker, a vibrator and the like, for example; the storage device 808 comprising a magnetic tape, a hard disk and the like, for example; and a communication device 809. The communication device 809 may allow the electronic device 800 to be in wireless or wired communication with other devices for data exchange. Although FIG. 8 shows the electronic device 800 having various means, it should be understood that it is not required to implement or provide all the means shown. More or fewer devices may alternatively be implemented or provided.

In particular, according to the embodiments of the present disclosure, the process described above with reference to the flowcharts may be implemented as a computer software program. For example, according to an embodiment of the present disclosure, a computer program product is provided and comprises a computer program carried on a non-transitory computer-readable medium, and the computer program includes a program code for executing the methods shown in the flowcharts. In such an embodiment, the computer program may be downloaded and installed from a network via the communication device 809, or installed from the storage device 808, or installed from the ROM 802. The computer program, when executed by the processing device 801, serves the above functions defined in the methods of the embodiments of the present disclosure.

It should be noted that the computer-readable medium as described in the present disclosure may be a computer-readable signal medium or a computer-readable storage medium or any combination thereof. The computer-readable storage medium may be, for example, but is not limited to, an electrical, magnetic, optical, electromagnetic, infrared, or semiconductor-based system, apparatus, or device, or any combination thereof. More specific examples of the computer-readable storage medium may comprise, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program, and the program may be used by or in combination with an instruction execution system, apparatus, or device. Further, in the present disclosure, the computer-readable signal medium may comprise a data signal propagated in baseband or as a part of a carrier wave, in which the computer-readable program code is carried. This propagated data signal may be in various forms, comprising but not limited to electromagnetic signals, optical signals, or any suitable combination thereof. The computer-readable signal medium may also be any computer-readable medium other than the computer-readable storage medium, and the computer-readable signal medium may send, propagate, or transmit the program for use by or in connection with the instruction execution system, apparatus, or device. The program code included in the computer-readable medium may be transmitted by any suitable medium, comprising but not limited to an electric wire, an optical cable, radio frequency (RF) and the like, or any suitable combination thereof.

In some embodiments, any currently known or future-developed network protocol such as Hyper Text Transfer Protocol (HTTP), for example, may be used for communication and may be interconnected with digital data communications (e.g., communication networks) in any form or medium. Examples of the communication networks comprise local area network (LAN), wide area network (WAN), inter-network (e.g., the Internet), and end-to-end network (e.g., ad hoc end-to-end network), as well as any currently known or future developed networks.

The computer-readable medium may be included in the electronic device or may stand alone and not be assembled in the electronic device.

The above-mentioned computer-readable medium carries one or more programs. The above-mentioned one or more programs, when executed by the electronic device, causes the electronic device: in response to a predetermined trigger operation, obtaining information of at least one team; determining, based on the information of the at least one team, information display structure of the at least one team; presenting the information of the at least one team in the session list based on the information display structure of the at least one team; wherein the information display structure of a team comprises: team information and at least one group information; wherein, the team information comprises a team avatar, and a group avatar is excluded from the group information.

In some embodiments, the first display area comprises a team avatar display area and a team other information display area; and/or, the second display area comprises at least one sub-display area each for presenting first group information of a group.

In some embodiments, for a team, a position of the second display area is determined based on a display position of a team avatar within the first display area or a display position of other information of the team, a display position of the first group information being presented with an indentation relative to the display position of the team avatar.

In some implementations, the first trigger operation comprises: a selection operation on a team filtering tag.

In some embodiments, the above-mentioned one or more programs, when executed by the electronic device, causes the electronic device: present a first number of messages in a display area of the team filtering tag, the first number being acquired based on the number of messages of a second predetermined type of messages in a first predetermined type of groups for all teams.

In some embodiments, the first predetermined type of groups comprises all groups, or comprises groups with a message reminder turned on; and the second predetermined type of messages comprise unread messages, or messages mentioning a predetermined user.

In some implementations, the first information display interface is a session flow area in a communication client interface.

In some implementations, the team presented in the first information display interface has an expanded state and a collapsed state; team information of a team in the first information display interface is presented and first group information of a group associated with the team is hidden in response to a collapsing operation on the team; and team information of a team and first group information of each group associated with the team are presented in the first information display interface in response to an expanding operation on the team.

In some embodiments, the above-mentioned one or more programs, when executed by the electronic device, causes the electronic device: present a state switching control within the first display area; and in response to the state switch control of the team being triggered, switching a display state of the team; wherein a present form of the state switching control of the team is different if information of a team is in a different display state.

In some implementations, if information of a team is in an expanded state, the number of unread messages is excluded from the presented team information; or, if information of a team is in a collapsed state, the presented team information of the team comprises: a total number of unread messages in groups of the team, or a total number of unread messages in a group of the team with a message reminder turned on.

In some embodiments, when if information of a team is in an expanded state, presented first group information of a group associated with the team comprises a total number of unread messages of the group.

In some implementations, the first group information comprises at least one of: a group name, the number of unread messages in a group, and the number of members in the group.

In some embodiments, in accordance with a determination that a first linkage condition is satisfied, the team avatar matches a team name of the team, wherein the first linkage condition indicates a condition in which the team avatar changes along with the team name.

In some embodiments, the team avatar matching a team name comprises presenting all or part of the team name in the team avatar.

In some embodiments, the above-mentioned one or more programs, when executed by the electronic device, causes the electronic device: in accordance with a determination that the first linkage condition is satisfied and in response to a change of the team name, changing the team avatar to match the changed team name; and/or, in response to the team avatar being changed, remaining the team name unchanged.

In some implementations, the first linkage condition comprises: the team avatar remaining unedited by a user before a current point of time.

In some embodiments, in accordance with a determination that a second linkage condition is satisfied, a group avatar of a default communication group of the team is consistent with the team avatar of the team, wherein the second linkage condition indicates a condition in which the group avatar of the default communication group changes along with the team avatar.

In some embodiments, the above-mentioned one or more programs, when executed by the electronic device, causes the electronic device: in accordance with a determination that the second linkage condition is satisfied and in response to a change of the team avatar of the team, changing the group avatar of the default communication group to be consistent with the changed team avatar; and/or, in response to the group avatar of the default communication group is changed, remaining the team avatar of the team unchanged.

In some implementations, the second linkage condition comprises: the group avatar of the default communication group remaining unedited by a user before a current point of time.

In some embodiments, the above-mentioned one or more programs, when executed by the electronic device, causes the electronic device: if a new group belonging to the team is created in a group creation page of the team, generating a group avatar of the new group based on a group name of the new group, or based on a group avatar setting operation of a user; and if an existing group is added to the team, remaining an original group avatar of the existing group unchanged, or generating a group avatar of the existing group based on a group avatar setting operation of the user.

In some embodiments, the above-mentioned one or more programs, when executed by the electronic device, causes the electronic device: in response to an operation of presenting a second information interface, presenting group avatar information of the group associated with the team within a specified area in the second information interface.

In some embodiments, the second information interface comprises one or more of the following: a session flow area, if a filtering tag other than a team filtering tag is selected; a session details interface for the group associated with the team; or an interface presenting a group card of the group associated with the team

Computer program code for performing the operations of the present disclosure may be written in one or more programming languages, comprising but not limited to object-oriented programming languages-such as Java, Smalltalk, C++, and comprising conventional procedural programming languages-such as “C” or similar programming languages. The program code may execute entirely on the user's computer, partly on the user's computer, as a stand-alone software package, partly on the user's computer and partly on a remote computer or entirely on the remote computer or server. In situations involving remote computers, the remote computer can be connected to the user's computer through any kind of network, comprising a local area network (LAN) or a wide area network (WAN), or it can be connected to an external computer (such as an Internet service provider through Internet connection).

The flowcharts and block diagrams in the accompanying drawings illustrate the architecture, functionality, and operations of systems, methods, and computer program products that may be implemented in accordance with various embodiments of the present disclosure. In this regard, each block in the flowchart or block diagram may represent a module, segment, or portion of code that contains one or more logic functions that implement the specified executable instructions. It should also be noted that, in some alternative implementations, the functions noted in the block may occur out of the order noted in the figures. For example, two blocks shown one after another may actually execute substantially in parallel, or they may sometimes execute in the reverse order, depending on the functionality involved. It will also be noted that each block of the block diagram and/or flowchart illustration, and combinations of blocks in the block diagram and/or flowchart illustration, can be implemented by special purpose hardware-based systems that perform the specified functions or operations, or can be implemented using a combination of specialized hardware and computer instructions.

The units involved in the embodiments described in the present disclosure can be implemented in software or hardware. The name of a unit does not constitute a limitation on the unit itself under certain circumstances. For example, the display unit may also be a unit used to present information of at least one team in the session list.

The functions described above herein may be performed, at least in part, by one or more hardware logic components. For example, and without limitation, exemplary types of hardware logic components that may be used comprise: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable media may comprise, but are not limited to, electronic, magnetic, optical, electromagnetic, infrared, or semiconductor systems, devices or devices, or any suitable combination of the foregoing. More specific examples of machine-readable storage media would comprise one or more wires based electrical connection, laptop disk, hard drive, random access memory (RAM), read only memory (ROM), erasable programmable read only memory (EPROM or flash memory), optical fiber, portable compact disk read-only memory (CD-ROM), optical storage device, magnetic storage device, or any suitable combination of the above.

The above description is only a preferred embodiment of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions as disclosed in the present disclosure.

Furthermore, while the operations are depicted using a particular order, this should not be construed as requiring that the operations are performed in the particular order shown or in sequential order of execution. Multitasking and parallel processing may be advantageous in certain environments. Similarly, while several specific implementation details are comprised in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logical actions, it should be understood that the subject matter limited in the appended claims is not necessarily limited to the particular features or actions described above. Rather, the particular features and actions described above are merely example forms of implementing the claims. With respect to the apparatus in the above embodiments, the specific manner in which the individual modules perform the operations has been described in detail in the embodiments relating to the method and will not be described in detail herein.

1-35. (canceled)

36. A method of information processing, comprising:
in response to a first trigger operation, obtaining information of at least one team, a team comprising more than two team members;
determining, based on the information of the at least one team, at least one group associated with the team for information exchange among team members of the team, wherein group information of a group is stored within a predetermined database, the group information comprising group avatar information and other information of the group;
presenting team information of the team within a first display area of a first information display interface, the presented team information comprising team avatar information and other information of the team; and
presenting first group information of the group associated with the team in a second display area that satisfies a predetermined positional relationship with the first display area of the first information display interface, the first group information comprising information other than the group avatar information.

37. The method of claim 36, wherein the first display area comprises a team avatar display area and a team other information display area; and/or,
the second display area comprises at least one sub-display area each for presenting first group information of a group.

38. The method of claim 36, wherein for a team, a position of the second display area is determined based on a display position of a team avatar within the first display area or a display position of other information of the team, a display position of the first group information being presented with an indentation relative to the display position of the team avatar.

39. The method of claim 36, wherein the first trigger operation comprises: a selection operation on a team filtering tag,
wherein the method further comprises:
presenting a first number of messages in a display area of the team filtering tag, the first number being acquired based on the number of messages of a second predetermined type of messages in a first predetermined type of groups for all teams.

40. The method of claim 39, wherein the first predetermined type of groups comprises all groups, or comprises groups with a message reminder turned on; and
wherein the second predetermined type of messages comprises unread messages, or messages mentioning a predetermined user.

41. The method of claim 39, wherein the first information display interface is a session flow area in a communication client interface.

42. The method of claim 36, wherein the team presented in the first information display interface is associated with an expanded state and a collapsed state;
wherein the method further comprises:
in response to a collapsing operation on the team, presenting team information of a team in the first information display interface and hiding first group information of a group associated with the team; and
in response to an expanding operation on the team, presenting team information of a team and first group information of each group associated with the team in the first information display interface.

43. The method of claim 42, wherein the method further comprises:
presenting a state switching control within the first display area; and
in response to the state switching control of the team being triggered, switching a display state of the team;
wherein a present form of the state switching control of the team is different if information of a team is in a different display state.

44. The method of claim 42, wherein, if information of a team is in an expanded state, the number of unread messages is excluded from the presented team information; or,
if information of a team is in a collapsed state, the presented team information of the team comprises: a total number of unread messages in groups of the team, or a total number of unread messages in a group of the team with a message reminder turned on,
wherein if information of a team is in an expanded state, presented first group information of a group associated with the team comprises a total number of unread messages of the group.

45. The method of claim 36, wherein the first group information comprises at least one of: a group name, the number of unread messages in a group, and the number of members in the group.

46. The method of claim 36, wherein in accordance with a determination that a first linkage condition is satisfied, the team avatar matches a team name of the team, wherein the first linkage condition indicates a condition in which the team avatar changes along with the team name,
wherein the team avatar matching a team name comprises presenting all or part of the team name in the team avatar,

47. The method of claim 46, wherein the method further comprises:
in accordance with a determination that the first linkage condition is satisfied and in response to a change of the team name, changing the team avatar to match the changed team name; and/or,
in response to the team avatar being changed, remaining the team name unchanged.

48. The method of claim 46, wherein the first linkage condition comprises: the team avatar remaining unedited by a user before a current point of time.

49. The method of claim 36, wherein in accordance with a determination that a second linkage condition is satisfied, a group avatar of a default communication group of the team is consistent with the team avatar of the team, wherein the second linkage condition indicates a condition in which the group avatar of the default communication group changes along with the team avatar,
wherein the method further comprises:
in accordance with a determination that the second linkage condition is satisfied and in response to a change of the team avatar of the team, changing the group avatar of the default communication group to be consistent with the changed team avatar; and/or,
in response to the group avatar of the default communication group is changed, remaining the team avatar of the team unchanged.

50. The method of claim 49, wherein the second linkage condition comprises: the group avatar of the default communication group remaining unedited by a user before a current point of time.

51. The method of claim 36, wherein the method further comprises one or more of the following:
if a new group belonging to the team is created in a group creation page of the team, generating a group avatar of the new group based on a group name of the new group, or based on a group avatar setting operation of a user; and
if an existing group is added to the team, remaining an original group avatar of the existing group unchanged, or generating a group avatar of the existing group based on a group avatar setting operation of the user.

52. The method of claim 36, wherein the method further comprises:
in response to an operation of presenting a second information interface, presenting group avatar information of the group associated with the team within a specified area in the second information interface.

53. The method of claim 51, wherein the second information interface comprises one or more of the following:
a session flow area, if a filtering tag other than a team filtering tag is selected;
a session details interface for the group associated with the team; or
an interface presenting a group card of the group associated with the team.

54. An electronic device, comprising:
one or more processors; and
a storage device for storing one or more programs,
the one or more programs, when executed by the one or more processors, causing the one or more processors to implement acts comprising:
in response to a first trigger operation, obtaining information of at least one team, a team comprising more than two team members;
determining, based on the information of the at least one team, at least one group associated with the team for information exchange among team members of the team, wherein group information of a group is stored within a predetermined database, the group information comprising group avatar information and other information of the group;
presenting team information of the team within a first display area of a first information display interface, the presented team information comprising team avatar information and other information of the team; and
presenting first group information of the group associated with the team in a second display area that satisfies a predetermined positional relationship with the first display area of the first information display interface, the first group information comprising information other than the group avatar information.

55. A non-transitory computer-readable storage medium having a computer program stored thereon, wherein the computer program, when executed by a processor, implements acts comprising:
in response to a first trigger operation, obtaining information of at least one team, a team comprising more than two team members;
determining, based on the information of the at least one team, at least one group associated with the team for information exchange among team members of the team, wherein group information of a group is stored within a predetermined database, the group information comprising group avatar information and other information of the group;
presenting team information of the team within a first display area of a first information display interface, the presented team information comprising team avatar information and other information of the team; and
presenting first group information of the group associated with the team in a second display area that satisfies a predetermined positional relationship with the first display area of the first information display interface, the first group information comprising information other than the group avatar information.
